(19) United States
(12) Patent Application Publication
(10) Pub. No.: US 2006/0293137 A1
(43) Pub. Date: Dec. 28, 2006

(54) Pulley hub

(75) Inventor: Edson F. Lopes, Ann Arbor, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/159,059

(22) Filed: Jun. 22, 2005

(51) Int. Cl. F16H 55/36; F16H 55/49

(52) U.S. Cl. 474/166; 474/168

(57) ABSTRACT

A hub assembly having a hub body. The hub body includes a generally circular outer wall, a leg portion extending from the hub body and a central body portion. The outer wall is adapted for engagement with a driving belt. The central body portion is adapted to fixedly attached the hub body to a structure. An elastomeric material is attached to the leg portion. An inertia ring is attached to the elastomeric material.

### FIELD OF THE INVENTION

The present invention relates to pulley hubs, and more specifically to pulley hubs having an inertia ring that is not used as a driving member.

### BACKGROUND OF THE INVENTION

Pulley hubs have typically been comprised of two main structures, an inertia ring and a hub body. The hub body was used for fixed coupling between the pulley hub and a structure. The inertia ring also served as a driving member, being coupled to the hub by an elastomeric structure, thereby rotatably driving the hub. The elastomeric structure served two main purposes, connecting the inertia ring to the hub and damping torsional vibrations of the pulley hub. Using the elastomeric structure as a connector between the driving member (inertia ring) and the hub body often results in wear on the elastomeric material, leading to durability issues. Further, having the inertia ring as part of the pulley hub drive assembly requires the use of a different pulley hub each time there is an application having different torsional vibration frequencies.

Other issues also result from the use of a multi-piece pulley hub. One of these issues may be a tolerance stack-up condition resulting from the use of multiple parts, or multiple manufacturing operations, effecting belt-positioning on the driving member. The weight of pulley hubs may also be increased to accommodate these tolerance issues. Some pulley hubs now formed by casting may use more material than is actually required in order to allow machining of the pulley hub after it has been manufactured to overcome the tolerance stack-up issues. This not only results in wasted material, resulting in higher material cost, but can also result in higher manufacturing costs due to an increase in the number of machining processes required.

### SUMMARY OF THE INVENTION

The present invention provides a hub assembly having a hub body. The hub body includes a generally circular outer wall, a leg portion extending from the hub body and a central body portion. The outer wall is adapted for engagement with a driving belt. The central body portion is adapted to fixedly attach the hub body to a structure. An elastomeric material is attached to the leg portion. An inertia ring is attached to the elastomeric material. This results in a reusable hub body. The same hub body may be used for a variety of applications. The only parts that may need to be adjusted are the elastomeric structure and the inertia ring. Further, the elastomeric structure has improved durability since it does not need to withstand the loads associated with the belt driving the pulley hub.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an engine having a pulley hub according to the teachings of the present invention.

FIG. 2 is a cross section of the pulley hub of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

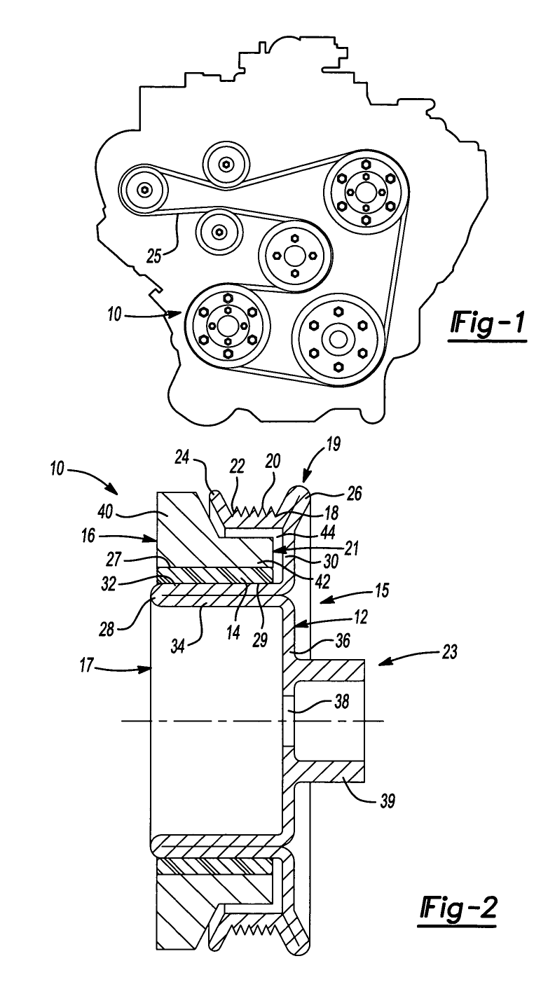

Referring to the drawings, FIGS. 1 and 2 show a pulley hub assembly 10. The pulley hub assembly 10 can include a hub body 12, an elastomeric structure 14 and an inertia ring 16.

The hub body 12 can be a generally continuous body having a front side 15 and a rear side 17. The hub body 12 can include a belt-engaging portion 19, an inertia ring receiving portion 21 and a central body portion 23. The belt-engaging portion 19 can extend rearwardly from the outer radial extent of the hub body 12 and can include an axially extending generally cylindrical outer wall 18 adapted to engage a belt 25. The outer wall 18 can have a poly-V configuration 20 formed on its exterior surface 22. Inner and outer flange portions 24, 26 can extend radially from sides of the exterior surface 22, providing lateral support for a belt 25. In the present example, the hub body 12 is formed from stamped steel. However, it should be understood that many different manufacturing processes and materials could be used such as casting or roll-forming.

The inertia ring receiving portion 21 can include a leg portion 28 that is generally circular and extends rearwardly from the upper face 30. The leg portion 28 can be generally parallel to the outer wall 18. In the present example, the leg portion 28 extends farther rearwardly than the outer wall 18, but it should be understood that the leg portion 28 and outer wall 18 could have equal rearward extents or the outer wall 18 could have a greater rearward extent than the leg portion 28.

The leg portion 28 can include an upper leg portion 32 and a lower leg portion 34 generally parallel to and abutting one another. The leg portion 28 and the outer wall 18 can be integrally connected to one another by the upper face 30.

The inertia ring receiving portion 21 can be defined by the outer wall 18, the upper face 30 and the upper leg portion 32, forming a recess 44 to at least partially house the inertia ring 16 therein. Alternatively, the inertia ring receiving portion 21 can be defined by the lower leg portion 34 and the lower face 36 extending below the lower leg portion 34. Although not shown, this configuration allows for the mounting of an inertia ring 16 to the upper leg portion 32 of the hub body 12 and the mounting of an inertia ring to the lower leg portion 34.

The central body portion 23 can be primarily comprised of the lower face 36 extending below the lower leg portion 34. An aperture 38 can be located in the lower face 36 for fixedly mounting the pulley hub assembly 10 to a driven member, such as a crankshaft. A nose 39 may extend from the front side 15 and surround the circumference of the aperture 38.

The elastomeric structure 14 may be chosen from a variety of materials depending on the stiffness required for the particular application. In the present example, the elastomeric structure 14 is a rubber. The elastomeric structure 14 can be bonded to the upper leg portion 32, as shown in FIG. 1, or alternatively to the lower leg portion 34 (not shown). The elastomeric structure 14 can be bonded to the hub body 12 using a variety of adhesive materials, one such example being an adhesive glue. The elastomeric structure 14 can have a generally rectangular cross-section having an upper surface 27 and a lower surface 29. The elastomeric structure 14 can extend along the upper leg portion 32 of the generally circular leg portion 28. The lower surface 29 can be bonded to the upper leg portion 32.

The inertia ring 16 can be fixedly attached to the upper surface 27 of the elastomeric structure 14. The inertia ring 16 can be any shape necessary to fit in a particular application. The present example shows one inertia ring 16 having a main body 40 and a leg 42 extending therefrom. The leg 42 is sized to fit within the recess 44 created by the outer wall 18, the upper leg portion 32 and the upper face 30 of the hub body 12. However, it should be understood that more than one inertia ring 16 could be used. There can be a series of inertia rings 16 and corresponding elastomeric structures 14 aligned axially. Alternatively, there can be an inertia ring 16 and an elastomeric structure 14 coupled to the upper leg portion 32 and another inertia ring 16 and elastomeric structure 14 coupled to the lower leg portion 34. There can also be a combination of the arrangements previously mentioned. Further, the inertia rings 16 can be formed by a process and/or a material different than that of the hub body 12. In the present example, the inertia ring 16 is formed from cast iron. The inertia rings 16 may also be formed from different materials (such as steel or powder metal) and/or processes with respect to one another. The elastomeric structures 14 may also be formed from different materials and/or processes relative to one another.

Typically different pulley hub applications will have different torsional vibrations. This results in the need to dampen frequency content specific to a particular application. This application-specific frequency content may require a different inertia ring mass or rubber stiffness in order to provide appropriate damping characteristics. The present invention allows the use of a common hub body 12 over a wide range of applications. The inertia ring 16 can be changed from application to application without changing the hub body 12 structure. The inertia ring 16 may be any shape able to fit within the attachment locations of a particular hub body 12. Further, the material can be altered, providing an opportunity for cost savings if the inertia ring 16 could be formed from a less expensive material.

The elastomeric structure 14 may not be as limited as those in the prior art as well. The elastomeric structure 14 is no longer required to withstand the load of the driving force of the belt 25 since the inertia ring 16 is no longer the driven member. This may allow materials to be used that were previously unavailable due to durability concerns. One benefit may be that the durability of the elastomeric structure 14 is greater due to the reduced loads imposed on it. Another benefit may be that the material cost of the elastomeric structure 14 may be reduced since other materials may now be available for the application.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A hub assembly comprising:
a hub body, said hub body including a generally circular outer wall, a leg portion and a central body portion, said outer wall adapted for engagement with a belt, said leg portion extending from said hub body and said central body portion adapted to fixedly attach said hub body to a structure;
an elastomeric structure attached to said leg portion; and
an inertia ring attached to said elastomeric structure.

2. The hub assembly of claim 1, wherein said leg portion is located radially inward of said outer wall and is generally parallel thereto.

3. The hub assembly of claim 1, further comprising a cavity formed by said outer wall and said leg portion, said cavity containing at least a portion of said inertia ring.

4. The hub assembly of claim 1, wherein said hub body is roll-formed as a unitary integral member.

5. The hub assembly of claim 1, wherein said inertia ring is cast.

6. The hub assembly of claim 1, wherein said hub body is driven by a crankshaft.

7. The hub assembly of claim 1, wherein said hub body is adapted to drive a belt drive.

8. The hub assembly of claim 1, wherein said elastomeric structure is made from rubber.

9. The hub assembly of claim 1, wherein said leg portion includes a first and a second surface, said first surface disposed radially inwardly of said second surface, said first surface having said elastomeric structure coupled thereto.

10. The hub assembly of claim 1, wherein at least 2 inertia rings are disposed axially relative to one another.

11. The hub assembly of claim 1, wherein said hub body is formed from a single piece of stamped steel.

12. The hub assembly of claim 1, wherein said inertia ring is formed from cast iron, steel, or powder metal.

13. The hub assembly of claim 1, wherein said hub body and said inertia ring are formed from different materials.

14. A hub assembly comprising:
a hub body formed from a single piece of material, said hub body including a generally circular outer wall, a leg portion and a central body portion, said outer wall adapted for engagement with a belt, said leg portion extending from said hub body and said central body portion adapted to fixedly attach said hub body to a structure;
an elastomeric structure attached to said leg portion; and
an inertia ring attached to said elastomeric material.

15. The hub assembly of claim 14, wherein said hub body is formed from stamped steel.

16. The hub assembly of claim 14, wherein said inertia ring is formed from iron.

17. A method of making a hub assembly including a hub body having a generally circular outer wall adapted to engage a belt, a leg portion and a central body portion, an elastomeric structure and an inertia ring, said method comprising:
forming the hub body from a first material;
attaching the elastomeric structure to the leg portion of the hub body;
forming the inertia ring from a second material; and
attaching the inertia ring to the elastomeric structure.

18. The method of claim 17, wherein forming the hub body includes forming the hub body from steel.

19. The method of claim 17, wherein forming the inertia ring includes forming the inertia ring from cast iron.
